(19) United States
(12) Patent Application Publication
(10) Pub. No.: US 2025/0130849 A1
(43) Pub. Date: Apr. 24, 2025

(54) METHOD AND SYSTEM FOR MIGRATING COMPUTING ENVIRONMENT

(71) Applicant: JPMorgan Chase Bank, N.A., New York, NY (US)

(72) Inventors: Hemant SATAM, Mumbai (IN); Pratik NIRGUN, Thane (IN); Kathan JOSHI, Mumbai (IN); Siddhika SHETTY, Mumbai (IN); Nidhi SHAH, Mumbai (IN); Asmi SHAH, Mumbai (IN)

(73) Assignee: JPMorgan Chase Bank, N.A., New York, NY (US)

(21) Appl. No.: 18/526,509

(22) Filed: Dec. 1, 2023

(30) Foreign Application Priority Data
Oct. 19, 2023 (IN) 202311071481

(51) Int. Cl. G06F 9/48

(52) U.S. Cl. CPC G06F 9/4856

(57) ABSTRACT

A method and a system for migrating a computing environment from a first platform to a second platform are disclosed. The method includes identifying a first set of components associated with the first platform and a second set of components associated with the second platform. The method further includes comparing the first set of components with the second set of components. Further, the method includes mapping the first set of components with the second set of components based on the comparison. The method further includes introducing the first set of components in the second platform based on the mapping. Further, the method includes updating at least one interface associated with the second platform for interaction with at least one entity. Thereafter, the method includes enriching, using a trained model, the second set of components associated with the second platform.

### CROSS-REFERENCE TO RELATED APPLICATIONS

This application claims priority benefit from Indian Application No. 202311071481, filed on 19 Oct. 2023 in the India Patent Office, which is hereby incorporated by reference in its entirety.

### FIELD OF THE DISCLOSURE

This technology generally relates to methods and systems for migrating a computing environment from a first platform to a second platform, and more particularly to methods and systems for migrating from a source platform to a target low code/no code platform.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

As is generally known, organizations are deploying low code or no code solutions to address automation requirements for operations. The continuous adoption of better low code or no code solutions has in turn created a need for developing migration tools. The migration tools are used for migrating the computing environment from a source platform to a target low code or no code platform.

The major problem faced by organizations in deploying low code or no code solutions is that there is an absence of solutions and tools that allow migration from one computing environment to a target low code/no code platform. The development of a comprehensive solution for migrating the computing environment is also difficult due to differences in the features and architecture in the source and target low code or no code computing platform. The migration of workflows from source to target platform needs to be done separately and is dependent on the volume of data. Further, the manual efforts and intervention required to migrate from source to target platform are not practically feasible and are cumbersome.

Hence, in view of these and other existing limitations, there arises an imperative need to provide an efficient solution to overcome the above-mentioned limitations and to provide a method and system for migrating the computing environment from a first platform to a second platform.

### SUMMARY

The present disclosure, through one or more of its various aspects, embodiments, and/or specific features or sub-components, provides, inter alia, various systems, servers, devices, methods, media, programs, and platforms for migrating a computing environment from a first platform to a second platform.

According to an aspect of the present disclosure, a method for migrating a computing environment from a first platform to a second platform is disclosed. The method is implemented by at least one processor. The method includes identifying, by at least one processor, a first set of components associated with the first platform and a second set of components associated with the second platform. Next, the method includes comparing, by the at least one processor, the first set of components with the second set of components. Next, the method includes mapping, by the at least one processor, the first set of components with the second set of components based on the comparison. Next, the method includes introducing, by the at least one processor, the first set of components in the second platform based on the mapping. Next, the method includes updating, by the at least one processor, at least one interface associated with the second platform for interaction with at least one entity. Thereafter, the method includes enriching, by the at least one processor using a trained model, the second set of components associated with the second platform.

In accordance with an exemplary embodiment, the first set of components comprises architectural components, software components, a sequence of execution of the software components, interfaces, and metadata associated with the first platform.

In accordance with an exemplary embodiment, the second set of components comprises architectural components, software components, a sequence of execution of the software components, interfaces, and metadata associated with the second platform.

In accordance with an exemplary embodiment, the at least one entity is one from among a database, a user, and an application.

In accordance with an exemplary embodiment, the method further includes introducing the first set of components in the second platform by adding at least one component to the second set of components, in an event that there is an absence of mapping between the first set of components and the second set of components.

In accordance with an exemplary embodiment, the method further includes enriching the second set of components by analyzing, by the at least one processor using the trained model, the first set of components and the second set of components; recommending, by the at least one processor using the trained model, a plurality of components for addition to the second set of components; and enriching, by the at least one processor using the trained model, the second set of components based on the recommendation of the plurality of components.

According to another aspect of the present disclosure, a computing device configured to implement an execution of a method for migrating a computing environment from a first platform to a second platform is disclosed. The computing device includes a processor; a memory; and a communication interface coupled to each of the processors and the memory. The processor may be configured to identify a first set of components associated with the first platform and a second set of components associated with the second platform. Next, the processor may be configured to compare the first set of components with the second set of components. Next, the processor may be configured to map the first set of components with the second set of components based on the comparison. Next, the processor may be configured to introduce the first set of components in the second platform based on the mapping. Next, the processor may be configured to update at least one interface associated with the second platform for interaction with at least one entity. Thereafter, the processor may be configured to enrich, using a trained model, the second set of components associated with the second platform.

In accordance with an exemplary embodiment, the first set of components comprises architectural components, software components, a sequence of execution of the software components, interfaces, and metadata associated with the first platform.

In accordance with an exemplary embodiment, the second set of components comprises architectural components, software components, a sequence of execution of the software components, interfaces, and metadata associated with the second platform.

In accordance with an exemplary embodiment, the at least one entity is one from among a database, a user, and an application.

In accordance with an exemplary embodiment, the processor may be further configured to introduce the first set of components to the second set of components, in an event that there is an absence of mapping between the first set of components and the second set of components.

In accordance with an exemplary embodiment, to enrich the second set of components, the processor may be further configured to analyze, using the trained model, the first set of components and the second set of components; recommend, using the trained model, a plurality of components for addition to the second set of components; and enrich, using the trained model, the second set of components based on the recommendation of the plurality of components.

According to yet another aspect of the present disclosure, a non-transitory computer-readable storage medium storing instructions for migrating a computing environment from a first platform to a second platform is disclosed. The instructions include executable code which, when executed by a processor, may cause the processor to identify a first set of components associated with the first platform and a second set of components associated with the second platform; compare the first set of components with the second set of components; map the first set of components with the second set of components based on the comparison; introduce the first set of components in the second platform based on the mapping; update at least one interface associated with the second platform for interaction with at least one entity; and enrich, using a trained model, the second set of components associated with the second platform.

In accordance with an exemplary embodiment, the first set of components comprises architectural components, software components, a sequence of execution of the software components, interfaces, and metadata associated with the first platform.

In accordance with an exemplary embodiment, the second set of components comprises architectural components, software components, a sequence of execution of the software components, interfaces, and metadata associated with the second platform.

In accordance with an exemplary embodiment, the at least one entity is one from among a database, a user, and an application.

In accordance with an exemplary embodiment, the executable code when executed further causes the processor to introduce the first set of components to the second set of components, in an event that there is an absence of mapping between the first set of components and the second set of components.

In accordance with an exemplary embodiment, to enrich the second set of components, the executable code when executed further causes the processor to analyze, using the trained model, the first set of components and the second set of components; recommend, using the trained model, a plurality of components for addition to the second set of components; and enrich, using the trained model, the second set of components based on the recommendation of the plurality of components.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for migrating a computing environment from a first platform to a second platform, in accordance with an exemplary embodiment.

FIG. 2 illustrates an exemplary diagram of a network environment for migrating a computing environment from a first platform to a second platform, in accordance with an exemplary embodiment.

FIG. 3 illustrates an exemplary system for migrating a computing environment from a first platform to a second platform, in accordance with an exemplary embodiment.

FIG. 4 illustrates an exemplary method flow diagram for migrating a computing environment from a first platform to a second platform, in accordance with an exemplary embodiment.

FIG. 5 illustrates a process flow diagram for implementing a method for migrating the computing environment from a first platform to a second platform, in accordance with an exemplary embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the problems associated with migrating computing environment from a source platform to a target low code/no code platform, the present disclosure provides a method and system for migrating a computing environment from a first platform to a second platform. The system first identifies a first set of components associated with the first platform and a second set of components associated with the second platform. In an example, the first set of components may include architectural components, software components, a sequence of execution of the software components, interfaces, and metadata associated with the first platform. Similarly, the second set of components may include architectural components, software components, a sequence of execution of the software components, interfaces, and metadata associated with the second platform. In another example, the first platform may be the source platform, and the second platform may be the target low code/no code platform. Next, the system compares the first set of components with the second set of components. In an example, the architectural components, metadata, and sequence of execution of software components associated with the first platform are compared with the architectural components, metadata, and sequence of execution of the software components associated with the second platform. Next, the system maps the first set of components with the second set of components based on the comparison. In an example, the architectural components, metadata, and sequence of execution associated with the first platform are mapped with the architectural components, metadata, and sequence of execution of the software components associated with the second platform. Next, the system introduces the first set of components in the second platform based on the mapping. In an example, the metadata and the sequence of execution of the software components are transferred to the second platform based on the mapping to enable migration to the second platform. In another example, in an event where there is an absence of mapping of an architectural component between the first and the second platform, the second platform is provided with the architectural components to allow the migration to the second platform. Next, the system updates at least one interface associated with the second platform for interaction with at least one entity. In an example, the at least one entity may be an application interacting with a second (target) platform. The system updates the interfaces of the second platform with the application to ensure appropriate interaction between the second platform and the application after the migration. Thereafter, the system may enrich the second set of components associated with the second platform. In an example, a trained model such as a large language model (LLM) provides recommendations for additional components to be added to a second set of components. The deployment team may incorporate the recommended components into the second set of components for enhanced performance of the second platform.

The first platform can include various computing environments and infrastructures. Examples of the first platform can include but are not limited only to legacy operating systems, old mainframe systems, outdated database versions, or even physical servers hosted in traditional data centers. Additionally, the first platform might comprise early versions of software solutions for big data processing, older e-commerce platforms, or proprietary built systems tailored to specific business needs, such as custom-built customer relationship management (CRM) systems. The first platform can include a system or environment from which an organization might consider migrating due to factors like outdated technology, scalability issues, support challenges, or a desire for enhanced features.

The second platform may include modern, advanced, and often cloud-based computing environments and solutions. Examples of the second platform can include but are not limited only to cloud platforms, which offer a multitude of services from virtual machines to managed databases. The second platform might also include contemporary software solutions for big data processing, updated e-commerce platforms, or standardized CRM platforms. Furthermore, the second platform could signify container orchestration systems, serverless computing models, or even artificial intelligence (AI) and machine learning (ML) platforms for data analytics. Essentially, the term embodies the updated, more efficient, and scalable systems to which an organization migrates to benefit from the latest technological advancements, better integration capabilities, and enhanced support structures.

The computing environment may include physical servers, central processing units (CPUs), storage devices, memory modules, networking equipment, and virtual machines. On the software side, the environment encapsulates operating systems, middleware, database management systems, applications, and even microservices or serverless functions. Beyond this, a computing environment may also include configuration settings and parameters that dictate how software components interact, security settings, user access controls, and networking configurations such as Internet Protocol (IP) addresses or domain settings. Furthermore, the computing environment could also involve runtime environments, which determine how specific software components are executed and interact during operations.

In an example, the computing environment is migrated from platform ‘A’ to platform ‘B’, where platform ‘B’ is a low code/no code platform. In general, the workflow and architectural components are transferred and introduced into platform ‘B’ using human efforts and expertise. However, this process is practically not feasible and is time-consuming. Thus, the conventionally available solutions are complicated, ineffective, and not recommended. Therefore, as per the solution of the present disclosure, the system is configured to automate the migration from platform ‘A’ to platform ‘B’ based on the mapping of components between the platforms. The system is further capable of recommending additional features and components for platform ‘B’ using trained models such as the LLM model. The recommendations enhance the functionality and capabilities of platform ‘B’ after the migration of the computing environment.

Therefore, the present disclosure aids in achieving migration from a source computing environment to a target low code/no code computing environment. The present disclosure addresses the absence of solutions for enabling automated migration between computing environments. The implementation of features of the present disclosure results in achieving better efficiency and performance owing to various factors. In an example, the factors include but are not limited to providing a solution for migrating the computing environment to a low code/no code platform, removing all manual intervention in the migration, facilitating the migration of workflows, such as network-attached storage (NAS) pooling, email pooling, optical character recognition (OCR) capabilities, and ensuring comparable performance metrics in target platform after the migration.

The migration solution offered by the present invention is capable of seamlessly transitioning between various computing environments. The environmental flexibility feature of the present invention ensures that the system is versatile enough to accommodate any setup, be it a traditional on-premises data center, a private cloud, a hybrid system, or any other computational construct. By leveraging dynamic component mapping, the solution can identify and harmonize differences between any originating and target environment without the need for specific preset configurations.

As businesses often navigate between cloud providers to tap into specific advantages, the migration tool of the present invention offers a seamless transition experience. The tool offers a capability to interact with major cloud platforms. Thus, the tool can recognize equivalent services across various cloud providers, allowing for smooth transitions. For example, if an organization wishes to move its data storage from one cloud storage provider to another, the solution ensures a smooth transition, maintaining data integrity and minimizing operational interruptions.

Further, the present invention also incorporates forward-compatible enhancements. The present invention may include tools like a middleware translator that facilitates easy integration of different middleware solutions. A distinct feature that sets it apart is its ability to handle data in a modular fashion, ensuring that data can be transferred independently of the associated applications. The modularity ensures that as the technological sphere grows and diversifies, the solution remains compatible, and ready to integrate with new environments or emerging cloud platforms.

It would be appreciated by the person skilled in the art that the present invention provides a migration solution that is not bound by environmental or cloud-specific limitations. Instead, the present invention offers versatility, adaptability, and forward compatibility, ensuring businesses can transition their computational assets smoothly and efficiently.

In an example, Company A, a prominent e-commerce business, has seen a dramatic increase in user traffic. Their in-house data centers, initially sufficient, are now struggling to handle the surge in demand, especially during peak sale periods. To ensure consistent performance and scalability, Company A contemplates moving their infrastructure to the cloud and chooses Company B, a leading cloud service provider. Company A's existing infrastructure is a blend of legacy systems and recent software solutions. Instead of a massive, simultaneous shift, they opt for a step-by-step migration approach. They begin by transferring their product catalog and customer databases. The phased approach facilitated by Company B ensures a seamless transition, allowing Company A to gradually adapt without disruptions. Navigating multi-cloud solutions: While Company B is their primary choice, Company A wants to ensure flexibility for potential future needs. They may decide to store their backup data with Company C, another cloud provider, to ensure data redundancy and risk mitigation. Company B's architecture and emphasizing adaptability ensures that Company A can smoothly integrate services from multiple cloud providers without compatibility issues. By embracing forward-compatibility. If Company A's business evolves, they may further decide to introduce AI-driven recommendations for their users. They integrated a new AI tool offered by Company B, designed to work seamlessly with existing cloud services. Company B's forward-thinking cloud infrastructure allows Company A to keep innovating and introducing new features to their platform with ease.

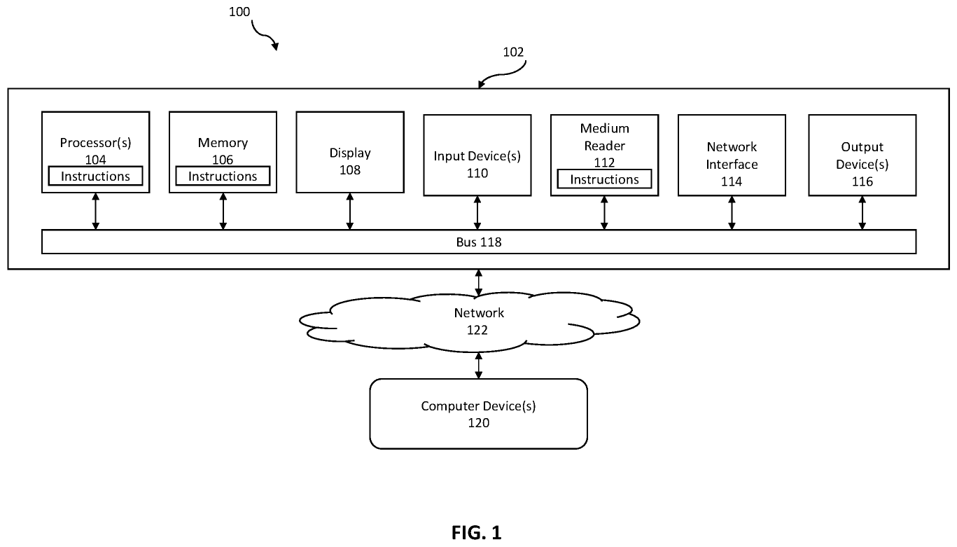

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As used herein, the first set of components may include architectural components, software components, a sequence of execution of the software components, interfaces, and metadata associated with the first platform.

As used herein, the second set of components may include architectural components, software components, a sequence of execution of the software components, interfaces, and metadata associated with the second platform.

As used herein, the at least one entity may be one from among a database, a user, and an application.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. Processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “network interface” may also be referred to as “communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for migrating a computing environment from a first platform to a second platform.

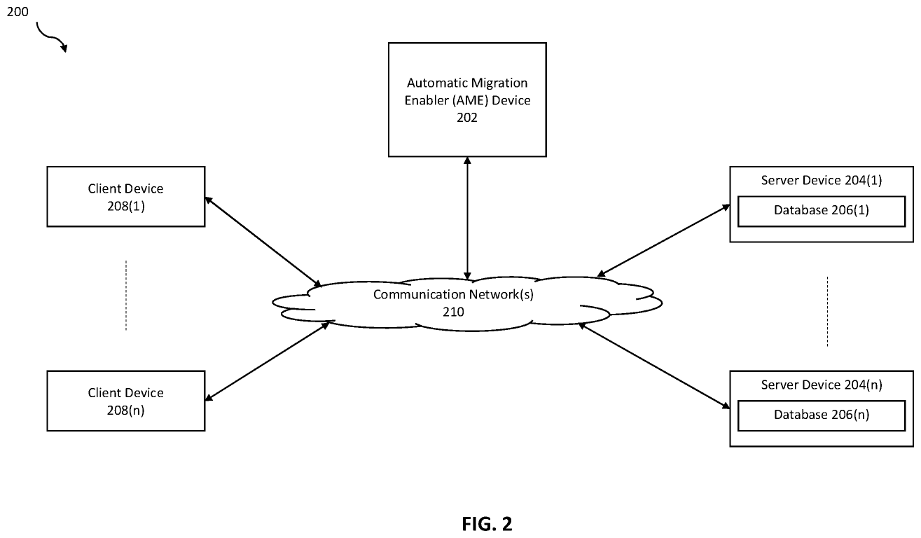

Referring to FIG. 2, a schematic of an exemplary network environment 200 for implementing a method for migrating a computing environment from a first platform to a second platform is illustrated. In an exemplary embodiment, the method is executable on any networked computer platform, such as, for example, a personal computer (PC).

The method for migrating a computing environment from a first platform to a second platform may be implemented by an Automatic Migration Enabler (AME) device 202. The AME device 202 may be the same or similar to the computer system 102 as described with respect to FIG. 1. The AME device 202 may store one or more applications that can include executable instructions that, when executed by the AME device 202, cause the AME device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the AME device 202 itself, may be located in the virtual server(s) running in a cloud-based computing environment rather than being tied to one or more specific physical network computing devices. Also, the application(s) may be running in one or more virtual machines (VMs) executing on the AME device 202. Additionally, in one or more embodiments of this technology, virtual machine(s) running on the AME device 202 may be managed or supervised by a hypervisor.

In the network environment 200 of FIG. 2, the AME device 202 is coupled to a plurality of server devices 204(1)-204(n) that hosts a plurality of databases 206(1)-206(n), and also to a plurality of client devices 208(1)-208(n) via communication network(s) 210. A communication interface of the AME device 202, such as the network interface 114 of the computer system 102 of FIG. 1, operatively couples and communicates between the AME device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AME device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and AME devices that efficiently implement the method for migrating a computing environment from a first platform to a second platform.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Networks (PSTNs), Ethernet-based Packet Data Networks (PDNs), combinations thereof, and the like.

The AME device 202 may be a standalone device or integrated with one or more other devices or apparatuses, such as one or more of the server devices 204(1)-204(n), for example. In one particular example, the AME device 202 may include or be hosted by one of the server devices 204(1)-204(n), and other arrangements are also possible. Moreover, one or more of the devices of the AME device 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the AME device 202 via the communication network(s) 210 according to the Hypertext Transfer Protocol (HTTP)-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases or repositories 206(1)-206(n) that are configured to store data related to the comparison and mapping of the first set of components and the second set of components, recommendations provided by the machine learning models and the training data for the machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AME device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the AME device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AME device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AME device 202, the server devices 204(1)-204(n), or the client devices 208(1)-208(n), for example, may be configured to operate as virtual instances on the same physical machine. In other words, one or more of the AME device 202, the server devices 204(1)-204(n), or the client devices 208(1)-208(n) may operate on the same physical device rather than as separate devices communicating through communication network(s) 210. Additionally, there may be more or fewer AME devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

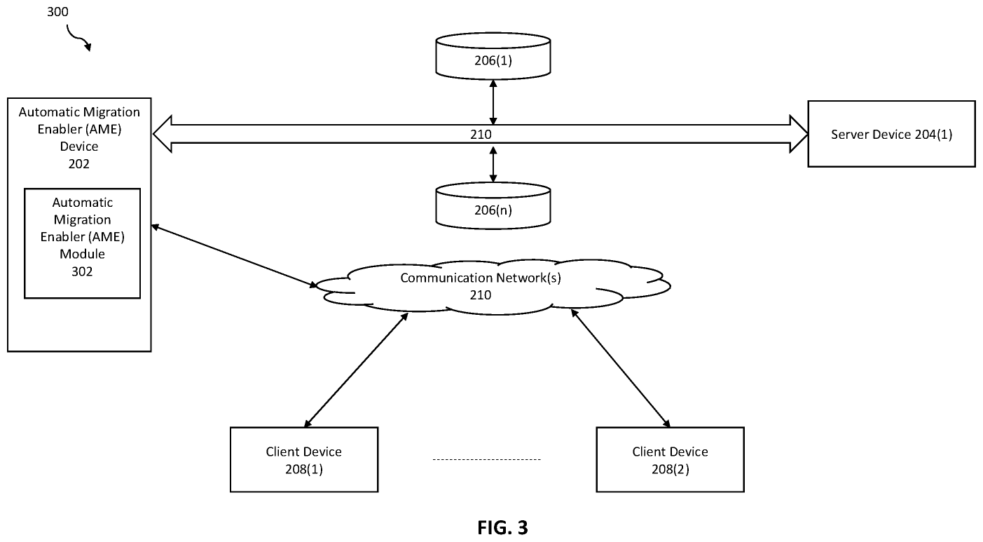

FIG. 3 illustrates an exemplary system for implementing a method for migrating a computing environment from a first platform to a second platform in accordance with an exemplary embodiment. As illustrated in FIG. 3, according to exemplary embodiments, the system 300 may comprise an AME device 202 including an AME module 302 that may be connected to a server device 204(1) and one or more repository from the repositories 206(1) . . . 206(n) via a communication network 210, but the disclosure is not limited thereto.

The AME device 202 is described and shown in FIG. 3 as including the AME module 302, although it may include other rules, policies, modules, databases, or applications, for example. As will be described below, the AME module 302 is configured to implement a method for migrating a computing environment from the first platform to the second platform.

An exemplary process 300 for implementing a mechanism for migrating a computing environment from a first platform to a second platform by utilizing the network environment of FIG. 2 is shown as being executed in FIG. 3. Specifically, a first client device 208(1) and a second client device 208(2) are illustrated as being in communication with AME device 202. In this regard, the first client device 208(1) and the second client device 208(2) may be “clients” of the AME device 202 and are described herein as such. Nevertheless, it is to be known and understood that the first client device 208(1) and/or the second client device 208(2) need not necessarily be “clients” of the AME device 202, or any entity described in association therewith herein. Any additional or alternative relationship may exist between either or both of the first client device 208(1) and the second client device 208(2) and the AME device 202, or no relationship may exist.

Further, the AME device 202 is illustrated as being able to access one or more repositories 206(1) . . . 206(n). The AME module 302 may be configured to access these repositories/databases for implementing a method for migrating a computing environment from a first platform to a second platform.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the AME device 202 via broadband or cellular communication. These embodiments are merely exemplary and are not limiting or exhaustive.

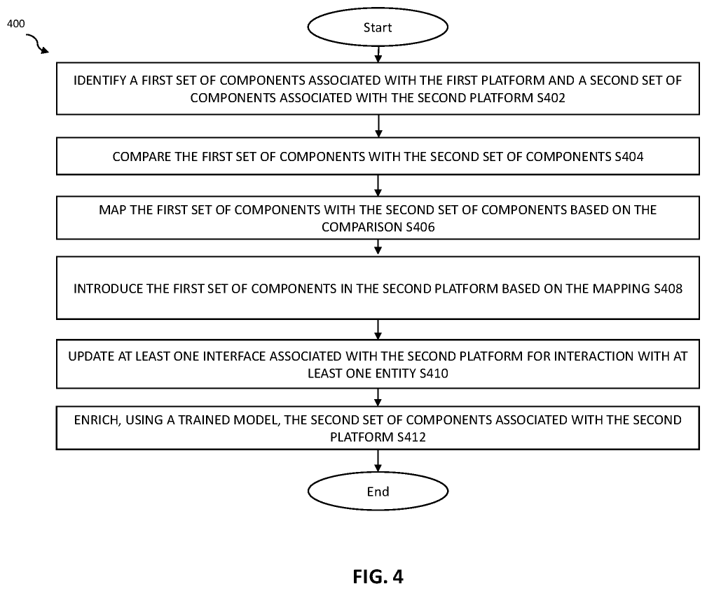

Referring to FIG. 4, an exemplary method 400 is shown for migrating computing environment from a first platform to a second platform in accordance with an exemplary embodiment. As shown in FIG. 4, the method begins following a need for deployment of a low code/no code platform, further involving a migration from the current platform to the target low code/no code platform.

At step S402, the method includes identifying, by at least one processor 104, a first set of components associated with the first platform and a second set of components associated with the second platform. In a non-limiting exemplary embodiment, the first set of components comprises architectural components, software components, a sequence of execution of the software components, interfaces, and metadata associated with the first platform. The second set of components comprises architectural components, software components, a sequence of execution of the software components, interfaces, and metadata associated with the second platform. In an example, the first platform is platform A, and second platform is platform B, where Platform A relates to the existing system, and Platform B relates to the new system to which it will be migrated. The platform A may be a generic existing infrastructure and the platform B is a low code/no code platform. The components identified with respect to platform A and platform include components such as the cloud-based storage required, workflow, metadata, steps involved in the execution of the software components, the sequence of execution of the software components, and the like.

In an embodiment, examples of metadata can include but are not limited only to task identifiers, task descriptions, data types, role permissions, timestamps, version history, dependency information, workflow state, configuration settings, user information, event logs, validation rules, API endpoints, file details, and error codes.

In an example, there are two computing platforms, Platform A and Platform B. Platform A relates to the existing (old) system, and Platform B is the new system to which it will be migrated. Metadata, in Platform A, could tag a database component as “DB_A_Old,” while in Platform B, a corresponding database component could be tagged as “DB_B_New.” The metadata might contain a mapping rule stating that “DB_A_Old” in Platform A corresponds to “DB_B_New” in Platform B. The metadata, in Platform A, could indicate that all date fields are stored in “MM/DD/YYYY” format. During migration, this metadata would instruct the processor to transform these date fields into a “YYYY-MM-DD” format used in Platform B. The metadata could contain a set of predefined test queries that the processor could execute against the migrated database component in Platform B to ensure data integrity. Should an issue arise, the metadata could store error codes. For example, an “Error_101” metadata tag could indicate that there is a data type mismatch between the two platforms. The metadata might record that the database migration occurred on a specific date and was performed by a particular user, creating an audit trail. The metadata might indicate that a machine learning model named “Model_v2” was used to enrich the database fields in Platform B, adding, for instance, a prediction score next to each record. The metadata could specify that Platform A's database component is at “Version 5,” while after migration, Platform B's database component is initiated at “Version 1.” The metadata could specify that only users with “Admin” roles can alter certain sensitive fields in Platform B after migration. The metadata in Platform A might contain a rule stating that any record with a null “Address” field should not be migrated. The processor would consult this metadata during the migration. The metadata could say that “DB_A_Old” is dependent on a specific API to fetch real-time data. The processor would then ensure that a similar API or its equivalent is set up for “DB_B_New” in Platform B.

At step S404, the method includes comparing, by the at least one processor 104, the first set of components with the second set of components. In an exemplary embodiment, the steps for the execution of the workflow are compared between Platform A and Platform B. In an another exemplary embodiment, the architectural components required for execution in Platform A are compared with the architectural components available with Platform B.

At step S406, the method includes mapping, by the at least one processor 104, the first set of components with the second set of components based on the comparison. The first set of components may include, but not limited only to architectural components, software components, a sequence of execution of the software components, interfaces, and metadata associated with the first platform. The second set of components may include, but not limited only to architectural components, software components, a sequence of execution of the software components, interfaces, and metadata associated with the second platform. In an exemplary embodiment, the steps involved in the execution on Platform A are mapped with the steps involved in the execution on Platform B. In an another exemplary embodiment, the metadata identified in Platform A may be used to create a JavaScript Object Notation (JSON) file of the metadata.

At step S408, the method includes introducing, by the at least one processor 104, the first set of components in the second platform based on the mapping. In a non-limiting exemplary embodiment, the method further includes introducing the first set of components in the second platform by adding at least one component to the second set of components, in an event that there is an absence of mapping between the first set of components and the second set of components. In an exemplary embodiment, introducing the first set of components in the second platform may include transferring the identified metadata, the sequence of execution of the software components, applying the sequence and connectors based on the sequence of execution of the software components, and the like. In another exemplary embodiment, in an event that there is an absence of mapping between the first set of components and the second set of components, the method may include introducing components to the second platform to enable migration and to ensure adequate performance after the migration.

At step S410, the method includes updating, by the at least one processor 104, at least one interface associated with the second platform for interaction with at least one entity. In an exemplary embodiment, the at least one entity is one from among a database, a user, and an application. In an example, the at least one interface enables the second platform to interact with entities such as a database, a user, an application, and the like. The method includes updating interfaces to enable interaction with entities after migration and ensure comparable performance metrics in the second platform. The at least one interface may be updated to provide new services, such as the services not provided by the first platform before the migration. The new services may also include the capabilities and features that are specific to the second platform.

At step S412, the method includes enriching, by the at least one processor 104 using a trained model, the second set of components associated with the second platform. In an embodiment, the method of enriching the second set of components by a trained model further includes analyzing, by the at least one processor 104 using the trained model, the first set of components and the second set of components. Next, the method includes recommending, by the at least one processor 104 using the trained model, a plurality of components for addition to the second set of components. Thereafter, the method includes enriching, by the at least one processor 104 using the trained model, the second set of components based on the recommendation of the plurality of components. In an example, the step of enriching the second set of components may involve the use of trained models (e.g., LLM based model). In another example, the plurality of recommended components is recommended by a trained model based on training data associated with the past migrations. The plurality of recommended components may be associated with the development of features and capabilities that are specific to the second platform. The recommended plurality of components for the second platform is used for enrichment based on the feedback received from users such as the software development team, deployment team, and the like.

In a non-limiting embodiment, the trained model corresponds to either a supervised or an unsupervised machine learning model. In an exemplary embodiment, machine learning may include supervised learning algorithms such as, for example, k-medoids analysis, regression analysis, decision tree analysis, random forest analysis, k-nearest neighbors' analysis, logistic regression analysis, K-fold cross-validation analysis, balanced class weight analysis, and the like.

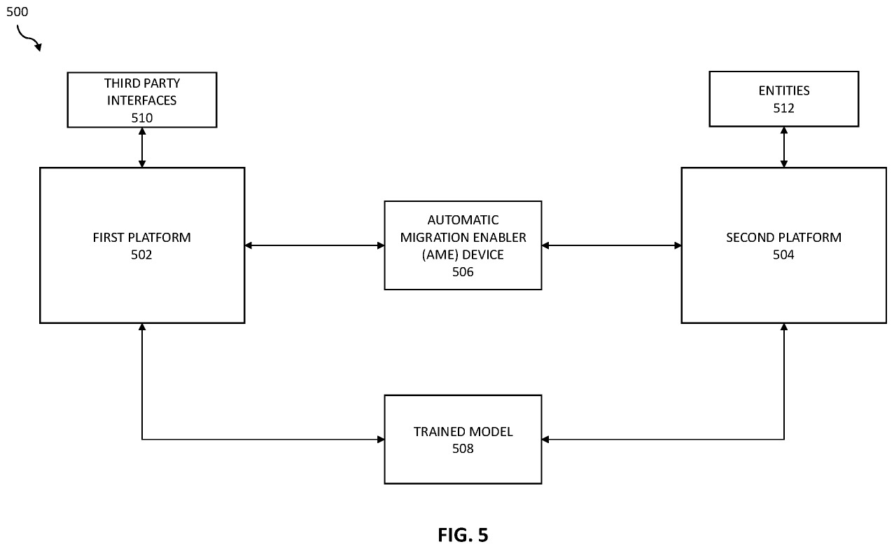

FIG. 5 illustrates a process flow diagram usable for implementing a method for migrating computing environment from a first platform to a second platform, in accordance with an exemplary embodiment. As illustrated in FIG. 5, the process flow 500 begins with identifying, by an AME device 506, a first set of components associated with the first platform 502 and second set of components associated with the second platform 504. The identification is followed by comparison and thereafter mapping of the first set of components and the second set of components. In an exemplary embodiment, the first set of components comprises architectural components, software components, a sequence of execution of the software components, interfaces, and metadata associated with the first platform. Similarly, the second set of components comprises architectural components, software components, a sequence of execution of the software components, interfaces, and metadata associated with the second platform. The comparison and mapping of the first set of components with the second set of components is done by the AME device 506. Next, the first set of components are introduced in the second platform based on the mapping. The introduction is done by the AME device 506 and may involve the transfer of the first set of components to second platform, where the transferred first set of components may include workflow, metadata, the sequence of execution of the software components, and the like. In another example, the introduction may involve adding architectural components in the second platform in an event where there is an absence of mapping of components between the first platform and the second platform. Next, at least one interface associated with the second platform for interaction with entities 512 is updated by the AME device 506. The interfaces enable the second platform to interact with entities such as a database, a user, an application, and the like. The AME device 506 updates interfaces to enable interaction with entities after migration and ensure comparable performance metrics in the second platform. Thereafter, the process further involves enriching the second set of components associated with the second platform using a trained model (e.g., LLM based model) 508. The recommendations are based on training data such as data associated with past migrations across computing environments. The recommendations are provided to ensure that the migration to the target low code/no code platform does not affect performance and in turn enables better configuration of components associated with the second platform.

Accordingly, with this technology, the process of migrating a computing environment from a source platform (such as first platform, or existing system) to a target platform (such as a second low code or no code platform, or new system) is disclosed. As evident from the above disclosure, the present solution provides significant technical advancement over the existing solutions by providing a solution for automatic migration of the computing environment from a first platform to a second low code or no code platform with minimum human intervention. The use of the present technology ensures in achieving better efficiency and performance owing to various factors. In an example, the factors include but are not limited to providing a solution for migrating computing environment to a low code or no code platform, removing all manual intervention in the migration, facilitating migration of workflows, such as NAS pooling, email pooling, OCR capabilities, and ensuring comparable performance metrics in target platform after the migration. Further, the trained model recommends additional components and modifications to ensure efficient performance of the second platform after migration. Therefore, as disclosed in the present disclosure, the method and system for migrating a computing environment from a first platform to a second platform help in providing a solution for migrating the computing environment to a low code or no code platform, removing all manual intervention in the migration, facilitating migration of workflows, such as NAS pooling, email pooling, OCR capabilities, and ensuring comparable performance metrics in second platform after the migration.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for migrating a computing environment from a first platform to a second platform is disclosed. The instructions include executable code which, when executed by a processor, may cause the processor to identify a first set of components associated with the first platform and a second set of components associated with the second platform; compare the first set of components with the second set of components; map the first set of components with the second set of components based on the comparison; introduce the first set of components in the second platform based on the mapping; update at least one interface associated with the second platform for interaction with at least one entity; and enrich, using a trained model, the second set of components associated with the second platform.

In an embodiment, the first set of components comprises architectural components, software components, a sequence of execution of the software components, interfaces, and metadata associated with the first platform. The second set of components comprises architectural components, software components, a sequence of execution of the software components, interfaces, and metadata associated with the second platform. The at least one entity is one from among a database, a user, and an application. The executable code when executed causes the processor to introduce the first set of components to the second set of components, in an event that there is an absence of mapping between the first set of components and the second set of components. To enrich the second set of components, the executable code when executed causes the processor to analyze, using the trained model, the first set of components and the second set of components; recommend, using the trained model, a plurality of components for addition to the second set of components; and enrich, using the trained model, the second set of components based on the recommendation of the plurality of components.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for migrating a computing environment from a first platform to a second platform, the method being implemented by at least one processor, the method comprising:
identifying, by the at least one processor, a first set of components associated with the first platform and a second set of components associated with the second platform;
comparing, by the at least one processor, the first set of components with the second set of components;
mapping, by the at least one processor, the first set of components with the second set of components based on the comparison;
introducing, by the at least one processor, the first set of components in the second platform based on the mapping;
updating, by the at least one processor, at least one interface associated with the second platform for interaction with at least one entity; and
enriching, by the at least one processor using a trained model, the second set of components associated with the second platform.

2. The method as claimed in claim 1, wherein the first set of components comprises architectural components, software components, a sequence of execution of the software components, interfaces, and metadata associated with the first platform.

3. The method as claimed in claim 1, wherein the second set of components comprises architectural components, software components, a sequence of execution of the software components, interfaces, and metadata associated with the second platform.

4. The method as claimed in claim 1, wherein the at least one entity is one from among a database, a user, and an application.

5. The method as claimed in claim 1, wherein the method further comprises introducing the first set of components in the second platform by adding at least one component to the second set of components, in an event that there is an absence of mapping between the first set of components and the second set of components.

6. The method as claimed in claim 1, wherein the method further comprises enriching the second set of components by:
analyzing, by the at least one processor using the trained model, the first set of components and the second set of components;
recommending, by the at least one processor using the trained model, a plurality of components for addition to the second set of components; and
enriching, by the at least one processor using the trained model, the second set of components based on the recommendation of the plurality of components.

7. A computing device configured to implement an execution of a method for migrating a computing environment from a first platform to a second platform, the computing device comprising:
a processor;
a memory; and
a communication interface coupled to each of the processor and the memory,
wherein the processor is configured to:
identify a first set of components associated with the first platform and a second set of components associated with the second platform;
compare the first set of components with the second set of components;
map the first set of components with the second set of components based on the comparison,
introduce the first set of components in the second platform based on the mapping;
update at least one interface associated with the second platform for interaction with at least one entity; and
enrich, using a trained model, the second set of components associated with the second platform.

8. The computing device as claimed in claim 7, wherein the first set of components comprises architectural components, software components, a sequence of execution of the software components, interfaces, and metadata associated with the first platform.

9. The computing device as claimed in claim 7, wherein the second set of components comprises architectural components, software components, a sequence of execution of the software components, interfaces, and metadata associated with the second platform.

10. The computing device as claimed in claim 7, wherein the at least one entity is one from among a database, a user, and an application.

11. The computing device as claimed in claim 7, wherein the processor is further configured to introduce the first set of components to the second set of components, in an event that there is an absence of mapping between the first set of components and the second set of components.

12. The computing device as claimed in claim 7, wherein to enrich the second set of components, the processor is further configured to:
analyze, using the trained model, the first set of components and the second set of components;
recommend, using the trained model, a plurality of components for addition to the second set of components; and
enrich, using the trained model, the second set of components based on the recommendation of the plurality of components.

13. A non-transitory computer readable storage medium storing instructions for migrating a computing environment from a first platform to a second platform, the instructions comprising executable code which, when executed by a processor, causes the processor to:
identify a first set of components associated with the first platform and a second set of components associated with the second platform;
compare the first set of components with the second set of components;
map the first set of components with the second set of components based on the comparison;
introduce the first set of components in the second platform based on the mapping;
update at least one interface associated with the second platform for interaction with at least one entity; and
enrich, using a trained model, the second set of components associated with the second platform.

14. The storage medium as claimed in claim 13, wherein the first set of components comprises architectural components, software components, a sequence of execution of the software components, interfaces, and metadata associated with the first platform.

15. The storage medium as claimed in claim 13, wherein the second set of components comprises architectural components, software components, a sequence of execution of the software components, interfaces, and metadata associated with the second platform.

16. The storage medium as claimed in claim 13, wherein the at least one entity is one from among a database, a user, and an application.

17. The storage medium as claimed in claim 13, wherein when executed by the processor, the executable code further causes the processor to introduce the first set of components to the second set of components, in an event that there is an absence of mapping between the first set of components and the second set of components.

18. The storage medium as claimed in claim 13, wherein to enrich the second set of components, wherein when executed by the processor, the executable code further causes the processor to:
analyze, using the trained model, the first set of components and the second set of components;
recommend, using the trained model, a plurality of components for addition to the second set of components; and
enrich, using the trained model, the second set of components based on the recommendation of the plurality of components.
